(19) United States
(12) Patent Application Publication
(10) Pub. No.: US 2005/0019446 A1
(43) Pub. Date: Jan. 27, 2005

(54) Infused sake and process for making same

(76) Inventors: Adrian Kawa, Los Angeles, CA (US); Allan Nathan, Los Angeles, CA (US); Anton Posniak, Los Angeles, CA (US); Guy Ravid, Los Angeles, CA (US)

Correspondence Address: K David Crockett;Crockett & Crockett, Suite 400, 24012 Calle de la Plata, Laguna Hills, CA, 92653, US

(21) Appl. No.: 10/500,735

(22) PCT Filed: Jan. 2, 2003
(86) PCT No.: PCT/US03/00196

(30) Foreign Application Priority Data
Jan. 2, 2002 (US) 10/038296

(51) Int. Cl. C12C 11/00

(52) U.S. Cl. 426/11

(57) ABSTRACT

A method of producing flavored sake from fruit or produce or concentrates of the same with a rich robust flavor, and having an extended shelf life is disclosed. The process includes the steps of first mixing sake with more or less finely divided fresh produce (20), aging the mixture in a cool dark place to transfer the produce flavor to the sake (25). Thereafter, the fresh produce is separated from the mixture (50), and the mixture undergoes rapid pasteurization (60). A preservative such as sulfur dioxide is then added (90) for further increasing the shelf life (95). The flavored sake product of the present invention can be transported and stored without refrigeration and without concern for product degradation or spoilage on the shelf.

This is a continuation of U.S. application Ser. No. 10/038,296 filed Jan. 2, 2002.

### BACKGROUND OF THE INVENTION

1. Field of the Invention

The current invention pertains to the art of alcoholic beverages and more particularly for a process to add natural flavors and essences from natural fruits to sake in a manner that does not impact the stability of the product.

2. Description of the Prior Art

Alcoholic beverages are at least as old as agriculture, which means alcoholic beverages date back to the New Stone Age. Virtually every human culture has one or more indigenous alcoholic beverages. Almost any aqueous solution containing dissolved sugar and exposed to air is likely to become infected by wild yeasts that ferment the sugars into alcohol and carbon dioxide. Thus, the widespread prevalence of alcoholic beverages is not that surprising.

Alcoholic beverages have generally been classified either by the source material that is fermented to make the beverage or by the alcoholic content of the finished beverage or by some combination of these criteria. Thus, beverages of low alcoholic content (generally less than about 9% alcohol) which are fermented from grains are usually considered to be beers. Wines, on the other hand, are fermented to a higher percentage of alcohol (generally 10-18% alcohol) and are usually fermented from fruit juice, exceptions being made which is fermented from honey and sake which is a unique dually fermented rice-based beverage. Although fermentation by yeast can yield alcohol levels approaching 18%, it is much more common for wine to be in the 13-14% alcohol range because alcohol becomes toxic to the yeast at higher concentrations. Alcohol toxicity slows and eventually stops the fermentation process preventing higher alcohol levels from being reached. Higher levels of alcohol also kill or inhibit bacteria stopping spoilage as well as fermentation.

Probably 20% of the wine consumed in the world is sake, a Japanese wine fermented from rice. Sake can be produced with alcohol contents as high as 20% although the beverage is usually diluted somewhat to a 14% alcohol level. The high level of alcohol reached by sake is related to a unique dual fermentation employing both Aspergillus oryzae and a more typical wine yeast. A unique Aspergillus-rice combination (koji) produces special enzymes that efficiently digest rice starch into fermentable sugars. This results in the unusually high alcohol content of the finished beverage.

Vodka, whiskey, and other alcoholic beverages with alcohol contents well above 20% are produced by distilling alcohol from a yeast-fermented beverage. Some types of higher alcohol beverages are produced by adding distilled alcohol to wine (e.g., sherry and port). Distilled alcohol is a good solvent for essential oils and essences, hence the ease with which flavored vodkas can be produced by adding flavoring fruits or spices. Many liquors and aperitifs are produced by using distilled alcohol (as high as 95% alcohol) to extract various flavoring materials after which the resulting extract is diluted with water and often sugar to make a flavored alcoholic beverages. Unfortunately, unless the alcoholic content of the resulting beverage is well above 15%, the material will not be stable and may start to ferment or even decay in storage—most liquors and aperitifs are at least 20% alcohol. Fermentation in storage is especially troublesome because the pressure of carbon dioxide can cause the bottles to explode forcefully. Refrigerating the liquids can greatly retard fermentation and spoilage but constant refrigeration is not practical in today's beverage storage and distribution channels.

Besides high alcohol liquors and aperitifs, it is also possible to impart fruit and other appealing flavors to lower alcoholic beverages such as wine. A classic case is the Spanish wine punch sangria in which fruit is macerated or marinated in wine so that flavor and fruit juices become mingled with the wine. Although the wine has sufficient alcohol to help facilitate extraction of the fruit flavors, it has insufficient alcohol to stabilize the resulting beverage. Therefore, the sangria is subject to spoilage and fermentation and must be freshly produced. Early commercial “wine cooler” products contained added sugar and fruit juice and experienced considerable stability problems. It is possible to add refined essences and artificial flavors to wine to make an ersatz sangria that is stable, but this is inferior in flavor to mixtures containing extract of real fruit or real fruit concentrates.

More recently, there has been a trend to produce fruit-flavored beverages from rice wine (sake) as opposed to grape wine. In many ways sake is a superior starting material because it has a less strong flavor that might mask the characteristics of the fruit and because it is available with a higher alcohol level than grape wine, thus more efficiently dissolving and extracting the fruit and other natural flavors. High quality flavored sake can be produced by steeping the sake with crushed fruits, spices, herbs or similar flavoring materials to produce a so-called “infused” sake, or real fruit concentrates can be mixed with the sake to produce a “blended” sake. In either case, considerable material from the natural fruit or other flavoring agent becomes suspended and dissolved in the sake. These products show the same lack of stability as natural sangria. If an attempt is made to store the material, it will spoil and/or ferment especially if not refrigerated. Stable flavored sake can be produced by adding highly refined fruit flavors and artificial essences; however, such products are inferior and lack the depth of flavor of natural fruit.

In the past, various processes have been utilized to increase the life of food products, including alcoholic beverages. Spoilage of alcoholic beverages can be caused by many factors, including, but not limited to, fermentation or other microbe growth (including bacterial growth which can change the beverage into vinegar), color changes from, for example, oxidation, other changes in appearance, for example, agglomeration of the solids; and, noticeable reduction in aromas and flavors.

Pasteurization is known to reduce or eliminate microbial instability and thereby decrease spoilage. Pasteurization is often required for ensuring stability of lower alcohol content products. Pasteurization is generally effected by heating the beverage to a certain elevated temperature (below boiling) and holding it at that temperature for a required time. However, standard pasteurization of sake containing real fruit infusion or extracts is not successful. The elevated temperature destroys or damages the delicate fruit flavors often resulting in a “burnt” or “cooked” taste.

Therefore, there is a considerable need to prepare sake infused with real fruit or blended with real fruit concentrate that is completely stable with an adequate shelf life with no appreciable loss of real fruit flavors.

### SUMMARY OF THE INVENTION

The present invention provides a method of producing flavored sake from whole fruit or produce or concentrates of the same with a rich, robust flavor, and having an extended shelf life, thereby making it amenable to commercial manufacturing and distribution.

The process of this invention comprises the steps of first mixing sake with more or less finely divided fresh produce in a container, sealing the container, and aging the mixture in a cool, dark place for a time sufficient to transfer the flavor of the produce to the sake. Thereafter, the fresh produce is separated from the mixture, and the mixture undergoes a rapid pasteurization process. A preservative such as sulfur dioxide is then added for further increasing the shelf life. Whole produce concentrate (e.g., fruit concentrate) can be substituted for the whole produce. In the case of concentrates, the aging time can be greatly reduced.

Other alternative preservatives that include potassium sorbate and/or sodium benzoate can be used in the invention.

The flavored sake product of the present invention can be transported and stored without refrigeration. In this way, alcoholic beverage distributors can distribute quantities of the flavored sake product to liquor stores and restaurants, where the flavored sake can be kept and displayed for sale to the consumer, without concern for product degradation or spoilage on the shelf.

It is therefore an object of the present invention to provide a process for producing flavored sake from fresh produce or fresh produce concentrate.

It is another object of the present invention to provide a process for producing flavored sake having a rich, robust flavor.

It is a further object of the present invention to provide a process for producing flavored sake having a long shelf life.

It is yet another object of the present invention to provide a flavored sake that does not require refrigeration during storage.

### DESCRIPTION OF THE FIGURES

FIG. 1 is a flow chart of the inventive process for use with fresh fruit or produce.

FIG. 2 is a flow chart of the inventive process for use with whole fruit or produce concentrate.

FIGS. 3 and 4 are charts showing the results of a microbiological stability study performed on pineapple infused sake using the alternative preferred embodiments of the inventive process.

### DETAILED DESCRIPTION OF THE INVENTION

The following description is provided to enable any person skilled in the art to make and use the invention and sets forth the best modes contemplated by the inventors of carrying out his invention. Various modifications, however, will remain readily apparent to those skilled in the art, since the general principles of the present invention have been defined herein specifically to provide a method for producing stable sake flavored with whole fruit or whole fruit concentrates.

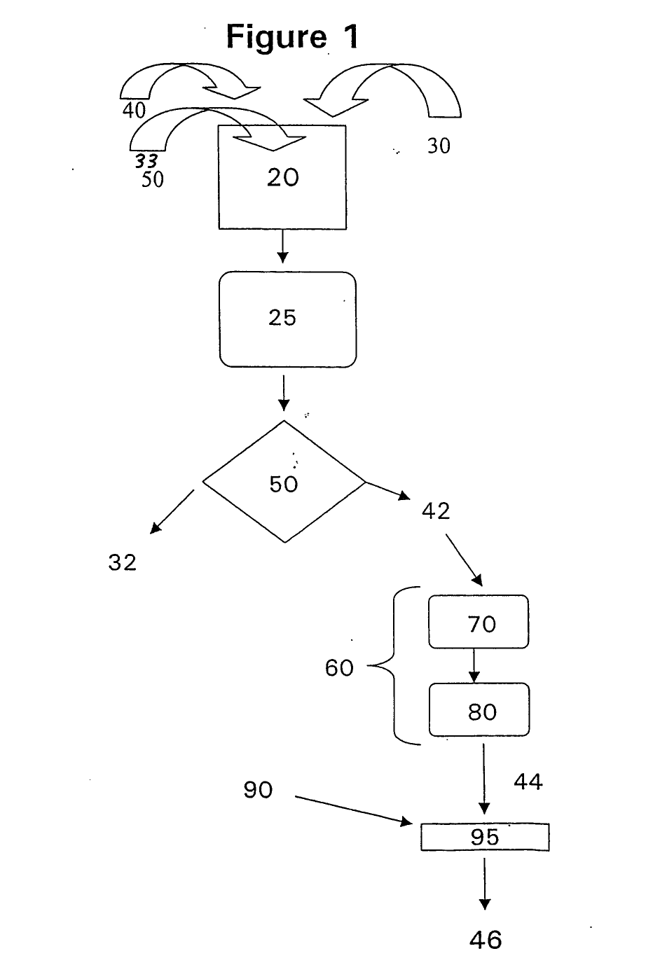

This invention relates to a method for flavoring sake with fresh produce. FIG. 1 shows a flow chart of the method of making infused sake according to the present invention. As previously explained, an “infused” product is produced by soaking chopped whole fruit or other flavor giving produce (e.g., herbs or spices) in sake. Alternatively, whole fruit or produce concentrate can be blended with sake to give a similar flavored product. Concentrate is especially attractive for producing the flavored sake when the flavoring fruit or produce is not in season. For the “infusion” process, a quantity of fresh produce 30 is added to an amount of sake 40 in an extraction container 20. Syrup 33 may also be added into container 20 to alter sweetness of the mixture. The container 20 is then sealed and stored in a light-free environment for about three to four weeks in the cold 25 (at a temperature of about 44° F.). The temperature may range from about 33° F. to as much as 50° F. After several weeks, the sake-soaked produce 32 is subjected to a separation step 50 in which the raw flavored sake 42, which now contains produce juices and other materials, is separated from the remaining fruit solids or pomace 32. The separation step 50 of the sake-soaked produce 32 from the raw infused sake 42 may be achieved by straining, filtration, pressing, centrifugation or similar separation process.

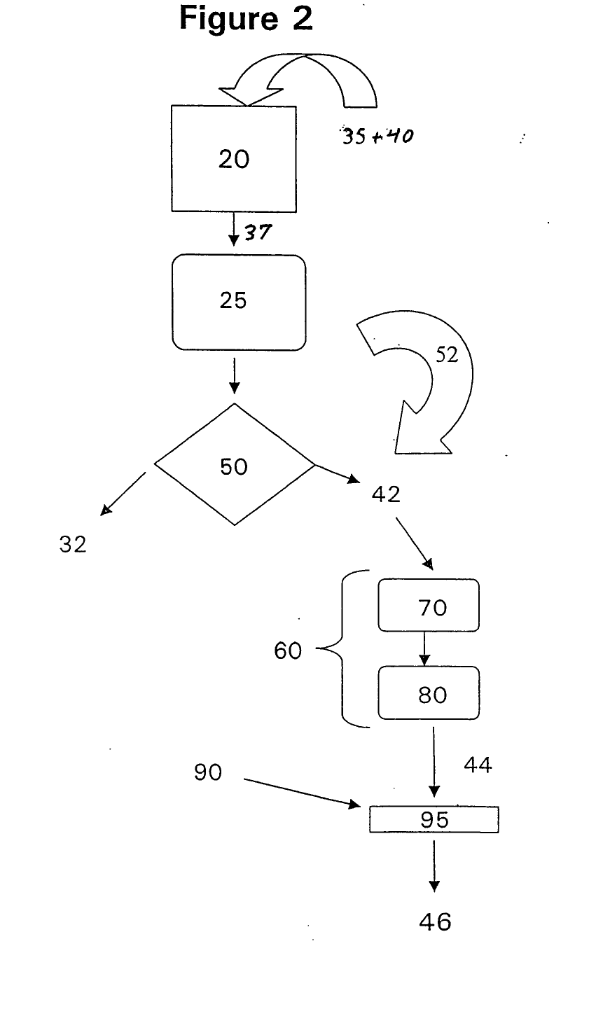

FIG. 2 shows the situation where a “blended” sake is to be produced; the sake 40 is directly mixed with fruit concentrate 35 or concentrate of other natural flavoring material in a pureed or liquified form. If the concentrate is finely homogenized (as is usual), the resulting blend is immediately subjected to the separation step 50. If the concentrate contains fruit pieces (e.g., frozen strawberry concentrate), the resulting mixture 37 may be stored 25 at a cold temperature for a period of time up to the three-four weeks of the infusion process. Generally, however, storage time will be much shorter than with the infusion process. Following any storage time, the raw flavored sake 42 is separated from excess fruit solids in the separation step 50. A completely liquified concentrate may not even require the separation step 50 (as shown by arrow 52).

In either FIG. 1 or FIG. 2, the resulting flavored infused sake 42 is then run through a flash pasteurizer 60 to make the stabilized flavored sake 44. In the flash pasteurization process 60, the raw flavored sake 42 is heated quickly 70 for a short period of time to a temperature high enough to eliminate harmful bacteria, then quickly cooled 80 to retain fresh flavors and nutrients. By precisely controlling time and temperature of the process, the stabilized flavored sake 44 is as close to the original natural flavor as possible. Generally, the flavored sake 42 is rapidly heated to a temperature between 160° F. and 165° F. for a time period of 15 to 30 seconds followed by immediate (very rapid) cooling to below 50° F. The exact parameters are adjusted depending on the flavoring material used. In the flash system 60, the raw flavored sake 42 is passed through the tubes of a heat exchanger so that the temperature can be rapidly and accurately altered. Other rapid pasteurization methods such as tunnel pasteurization may also be used provided the equipment provides sufficiently rapid heating and cooling. A tunnel pasteurizer normally heats and cools more gradually than a flash pasteurizer (but more quickly than conventional pasteurizers) and so may be less suitable for some delicate flavors. However, the tunnel system operates on the filled bottles whereas the flash system operates before the bottles are filled. This means that the flash system may be impacted by microbes found in the bottles before filling. That is, the flash system requires scrupulous sterilization of the bottles before filling.

Once the flash pasteurization process 60 is completed, the stabilized infused sake 44 is further treated with a preservative. The preservative serves at least two functions. It retards the growth of the small number of residual microbes that might survive the pasteurization process and/or maybe introduced during the bottling process. Secondarily, many preservatives are potent antioxidants and help to preserve the delicate fruit flavors particularly against room temperature storage. One preferred preservative is sulfur dioxide. This gas is widely used in the fruit juice industry and is very easy to meter into the bottles during filling or otherwise add to the flavored sake. Sulfur dioxide acts as a powerful antioxidant to preserve the product against oxidative deterioration. Sulfur dioxide is added at step 90 to the stabilized infused sake 44 at, for example, about 75 parts per million (creates mixture 95) to yield the final stabilized flavored sake product 46 of the present invention. Sulfites such as sodium or potassium sulfite may be readily substituted for sulfur dioxide. It should be emphasized that other antimicrobial preservatives such as sodium/potassium benzoate and sodium/potassium sorbate, commonly used in the beverage industry, can also be employed either alone or in combination with antioxidants and acidulants such as ascorbic acid, citric acid, flumaric acid, malic acid and derivatives (e.g., salts and esters) of these compounds. The point is that advanced rapid pasteurization methods are used to lower or eliminate microbes and an antioxidant-preservative is used to stabilize the fruit and guard against microbial contamination.

In alternative preferred embodiments of the present invention, as mentioned above, sulfur dioxide is replaced as a preservative material, and instead, potassium sorbate alone, sodium benzoate alone, or potassium sorbate and sodium benzoate in combination, are used as the preservative substance. According to these alternative preferred embodiments, either one or both potassium sorbate and sodium benzoate is added at step 90 to the stabilized infused sake 44, for example, each in an amount/ratio of about 300 ppm (parts per million) to yield the final stabilized flavored sake product 46 of the present invention. In these alternative preferred embodiments, pasteurization of the infused sake is preferably performed by a process where the temperature of the sake is raised to about 145° F. and each bottle of infused sake is hot filled at that temperature.

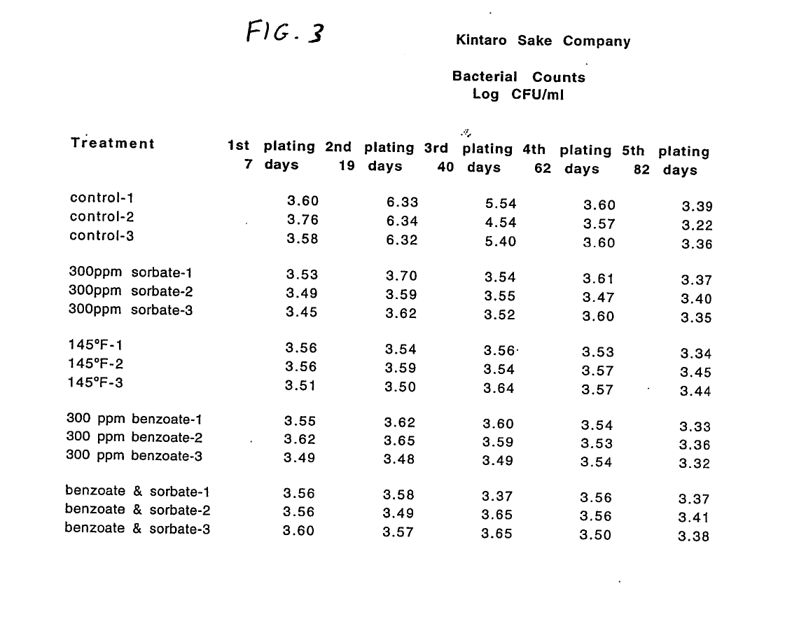

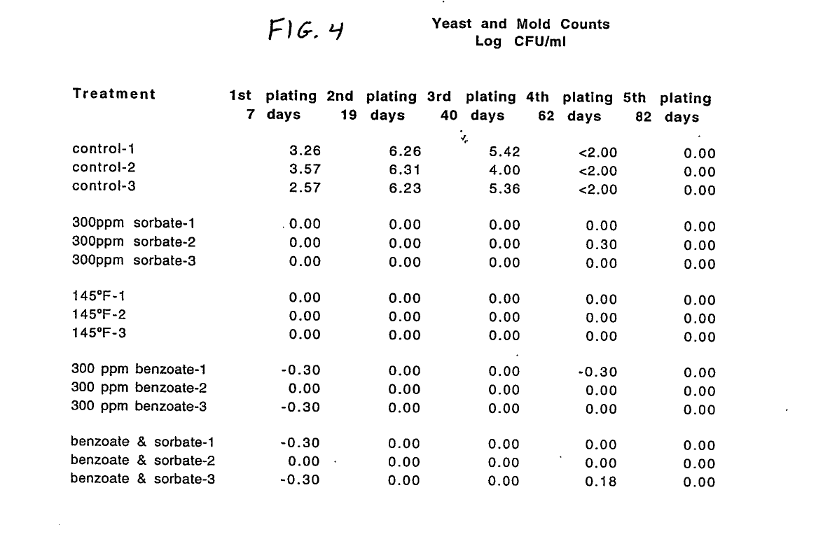

A study has been performed, which prove that these alternative preferred embodiments result in significantly enhanced microbiological stability in infused sake produced according thereto. More specifically, pineapple was used to infuse sake (other produce could also be used) and a batch of pineapple infused sake was prepared. From this batch, various samples were collected: a control sample (or Treatment) without further manipulation; a sample subjected to potassium sorbate as a preservative; a sample subjected to sodium benzoate as a preservative; and a sample subjected to both potassium sorbate and sodium benzoate as preservatives. The treatments having a preservative were subjected to hot filling at preferably about 145° F. (can be between about 140° F. to 150° F.). Following the hot fill process, three replications of each sample or treatment, including the control sample that was not subjected to the hot fill, were prepared in 100 ml samples. These were then placed in a 86° F. incubator as an accelerated shelf life test, and they were visually inspected for swelling and physical separation every 3 days and plated to access microbiological levels at weekly intervals. The microbiological analysis involved the determination of the levels of bacteria, yeasts and molds in the various sake samples. The results of the shelf life study over the course of an 82 day accelerated shelf life test are presented in FIGS. 3 and 4.

To assess the bacterial levels, Plate Count Agar (PCA) was used with duplicate 1 ml samples of each treatment and replicate treatments. The plates were incubated at 30° C. for 2 days before enumeration. The 30° C. holding is an accelerated shelf life study that is equivalent to double the time at 20° C., which is normal room temperature. The levels of yeast and molds are expressed as log₁₀ colony forming units (CFU)/milliliter. Yeast and mold were enumerated by taking 1-ml samples of the various treatments and mixing with acidified Potato Dextrose Agar (pH 3.5). There were no mold present in any of the samples, so the values presented for yeast and mold counts present solely yeast contamination levels. All of the various treatments, except for the control samples, showed no signed of spoilage over the entire 82 days of the study, which is represented by the constant level of bacterial counts and a yeast count of 0 for all replications of the treatments. From the data of the study presented in FIGS. 3 and 4, it is shown that spoilage of the infused sake will not occur with any of the treatments, except for the regular control samples which showed spoilage by virtue of the existence yeast and unstable bacteria levels. Of course, good sanitation and avoidance of contamination are still important in the preparation of the infused sake. This study supports the notion that the alternative preferred embodiments of the present invention, which use one or both of potassium sorbate and sodium benzoate as preservatives along with the hot fill pasteurization provide for a process for the creation of infused flavored sake with good flavor and having a microbiologically clean and stable form that can be transported and stored without refrigeration and without concern for product degradation or spoilage on the shelf.

Unlike other methods for enhancing the shelf life of flavored sake that use flavored syrups, artificial flavors or fruit extracts to avoid stability and product longevity concerns, the present invention enables consumers to experience the enhanced taste of infused or blended sakes created from fresh produce or concentrates of whole fruit. Yet, flavored sake made according to the inventive process can be shipped and stored without refrigeration and have an adequate shelf life without loss of quality.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A method of flavoring sake with fresh produce comprising the steps of:
contacting a quantity of sake with a quantity of finely divided fresh produce to form a produce sake mixture;
aging the produce sake mixture at a reduced temperature for a predetermined time;
separating the aged produce sake mixture into a raw flavored sake and insoluble material;
subjecting the raw flavored sake to a rapid pasteurization process to produce pasteurized flavored sake; and
adding a preservative to produce fully stabilized flavored sake.

2. The method according to claim 1, wherein the reduced temperature is between 33° F. and 50° F.

3. The method according to claim 1, wherein the rapid pasteurization process is selected from the group consisting of flash pasteurization and tunnel pasteurization.

4. The method according to claim 1, wherein the produce is selected from the group consisting of fruit, vegetables, herbs and spices.

5. The method according to claim 1, wherein the preservative is selected from the group consisting of sulfur dioxide, sodium sulfite, potassium sulfite, potassium sorbate, sodium sorbate, potassium benzoate and sodium benzoate.

6. The method according to claim 5, wherein the preservative further includes a material selected from the group consisting of ascorbic acid, ascorbic acid derivatives, citric acid, citric acid derivatives, malic acid and malic acid derivatives.

7. A method of flavoring sake with whole produce concentrate comprising the steps of:
contacting a quantity sake with a quantity of whole produce concentrate;
blending the whole produce concentrate and the sake to form a produce sake mixture;
subjecting the produce sake mixture to a rapid pasteurization process to produce pasteurized flavored sake; and
adding a preservative to the pasteurized flavored sake to produce fully stabilized flavored sake.

8. The method according to claim 7, wherein at least one of the steps of contacting and blending is carried out at a reduced temperature.

9. The method according to claim 8, wherein the reduced temperature is between 33° F. and 50° F.

10. The method of claim 7 further comprising the step of separating insoluble material from the produce sake mixture prior to the step of subjecting to a rapid pasteurization process.

11. The method according to claim 10, wherein at least one of the steps is carried out at a reduced temperature.

12. The method according to claim 11, wherein the reduced temperature is between 33° F. and 50° F.

13. The method according to claim 7, wherein the produce concentrate is selected from the group consisting of fruit concentrate, vegetable concentrate, herb concentrate and spice concentrate.

14. The method according to claim 7, wherein the preservative is selected from the group consisting of sulfur dioxide, sodium sulfite, potassium sulfite, potassium sorbate, sodium sorbate, potassium benzoate and sodium benzoate.

15. The method according to claim 14, wherein the preservative further includes a material selected from the group consisting of ascorbic acid, ascorbic acid derivatives, citric acid, citric acid derivatives, malic acid and malic acid derivatives.

16. The method according to claim 7, wherein the rapid pasteurization process is selected from the group consisting of flash pasteurization and tunnel pasteurization.

17. A method of flavoring sake with fresh produce comprising the steps of:
contacting a quantity of sake with a quantity of finely divided fresh produce to form a produce sake mixture;
aging the produce sake mixture at a reduced temperature for a predetermined time;
separating the aged produce sake mixture into a raw flavored sake and insoluble material;
subjecting the raw flavored sake to a hot fill pasteurization process to produce pasteurized flavored sake; and
adding a preservative to produce fully stabilized flavored sake.

18. The method according to claim 17, wherein said hot fill process is conducted at between 140° F. to 150° F.

19. The method according to claim 17, wherein said produce is selected from the group consisting of fruit, vegetables, herbs and spices.

20. The method according to claim 17, wherein said preservative is selected from the group consisting of potassium sorbate and sodium benzoate.
